(19) United States
(12) Patent Application Publication
(10) Pub. No.: US 2009/0049323 A1
(43) Pub. Date: Feb. 19, 2009

(54) SYNCHRONIZATION OF PROCESSORS IN A MULTIPROCESSOR SYSTEM

(76) Inventors: Robert R. Imark, Ft. Collins, CO (US); Raymond A. Gasser, Ft. Collins, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/838,630

(22) Filed: Aug. 14, 2007

(51) Int. Cl. G06F 15/76

(52) U.S. Cl. 713/375

(57) ABSTRACT

A method for synchronizing a first processor and multiple second processors is presented. In the method, each of the second processors waits at a second synchronization point after reaching a first synchronization point. The last of the second processors to reach the first synchronization point sends a signal to the first processor. The first processor waits at the first synchronization point until it receives the signal. After receiving the signal, the first processor initiates a launch of the second processors by launching at least one of the second processors. At least one of the second processors launched by the first processor launches another of the second processors in response to being launched by the first processor. Each of the second processors continues execution from the second synchronization point in response to being launched.

### BACKGROUND

Designers of computer systems consistently strive for increased processing capacity with each product generation. Many different approaches have been adopted to achieve the computing speeds currently enjoyed by users of such systems. Increased system clock speeds, integrated circuit design advances, wider data paths, and various other technological developments have all contributed to increasing the processing throughput of a single processor.

To further enhance computer capability, pipelined and parallel arrangements of multiple processing units have been pursued successfully. Parallel processing generally began with the use of “single instruction stream, multiple data stream” (SIMD) architectures, in which multiple processors perform identical operations on different data. In such a system, a single program line, or “thread,” of instructions is executed. More advanced “multiple instruction stream, multiple data stream” (MIMD) systems allow each processor to execute a completely diverse set of instructions, or a separate copy of the same set of instructions.

However, even in an MIMD system, some communication or cooperation between the various processors is typically required. One type of communication involves synchronizing two or more of the processors by requiring each of the processors to halt execution at a predetermined point in its execution thread (called “rendezvous”), and then begin execution again at the same or another predetermined location (termed “launch). One or more such synchronization points may be employed depending on the general nature and specific requirements of the overall task to be performed.

Typically, a multiprocessing computer system supports the use of synchronization points by way of complicated, specialized and nonstandard hardware functions. For example, a dedicated hardware implementation of a specialized broadcast interrupt may be supplied to support the use of launch points so that a single processor may inform all other processors of a launch quickly and efficiently. However, other multiprocessor systems may not provide such hardware due to the design and implementation expense involved in supporting such a specialized hardware construct.

### BRIEF DESCRIPTION OF THE DRAWINGS

FIG. 1 is a block diagram of a multiprocessor system according to an embodiment of the invention.

FIG. 2 is flow diagram of a method for synchronizing the processors of FIG. 1 according to an embodiment of the invention.

FIG. 3 is a graphic representation of execution of the processors in the multiprocessor of FIG. 1 according to another embodiment of the invention.

FIG. 4 is a diagram of a rendezvous table employed in the processor execution of FIG. 3 according to an embodiment of the invention.

FIG. 5 is a diagram of a launch table employed in the processor execution of FIG. 3 according to an embodiment of the invention.

### DETAILED DESCRIPTION

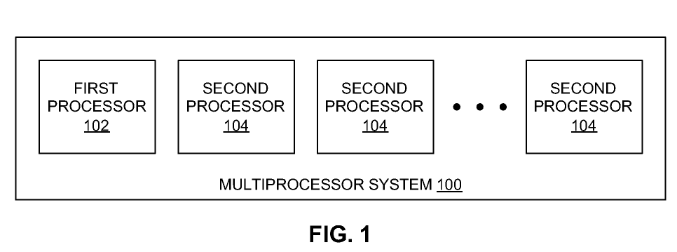

FIG. 1 provides a simplified block diagram of a multiprocessor system 100 including a first processor 102 and multiple second processors 104. In other embodiments, as few as two second processors 104, or many more than that depicted in FIG. 1, may be included. The multiprocessor system 100 may employ any type of multiprocessor architecture in which synchronization of two or more of the processors is desired. One possible architecture for the multiprocessor system may be a symmetric multiprocessing (SMP) system, although any of a plethora of other multiprocessor architectures may benefit from the inventive concepts described below.

While the first processor 102 is distinguished from the second processors 104, the first processor 102 and the second processors 104 may all be equivalent in terms of physical and electronic construction. The first processor 102 is instead distinguished in terms of its role in the synchronization of the processors 102, 104 from that of the second processors 104, as described in greater detail below. Further, each of the second processors 104 serve a similar synchronization function. However, the second processors 104 may or may not be similar in design and construction to each other. Only the functionality of the processors 102, 104 as described below is relevant to the embodiments presented herein.

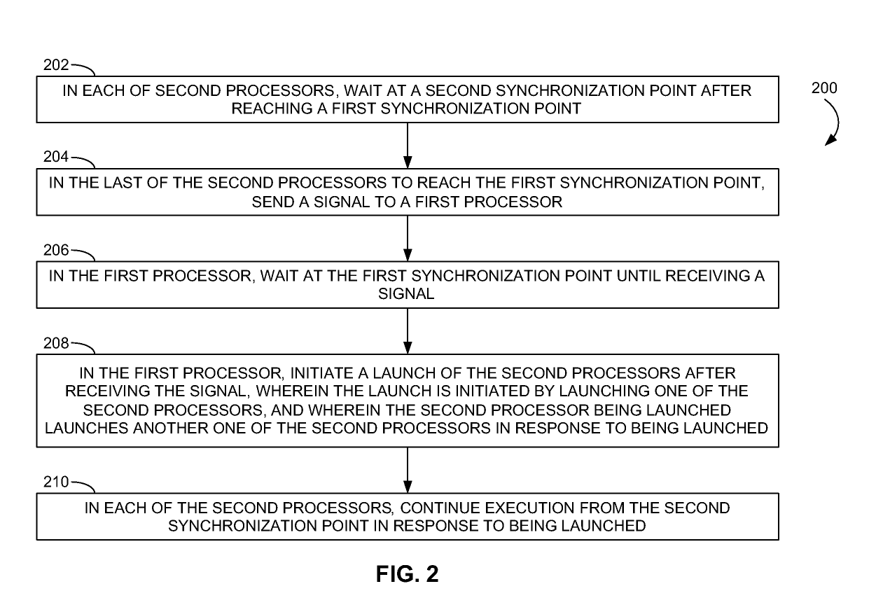

FIG. 2 presents by way of a flow diagram a method 200 of synchronizing the processors 102, 104 of FIG. 1. In the method 200, each of the second processors 104 waits at a second synchronization point after reaching a first synchronization point (operation 202). The last of the second processors 104 to reach the first synchronization point sends a signal to the first processor 102 (operation 204). The first processor 102 waits at the first synchronization point until receiving the signal (operation 206), and initiates a launch of the second processors 104 after receiving the signal (operation 208). More specifically, the first processor initiates the launch by launching at least one of the second processors 104, wherein the second processor 104 being launched launches another one of the second processors 104 in response to being launched. Each of the second processors 104, in response to being launched, continues execution from the second synchronization point (operation 210).

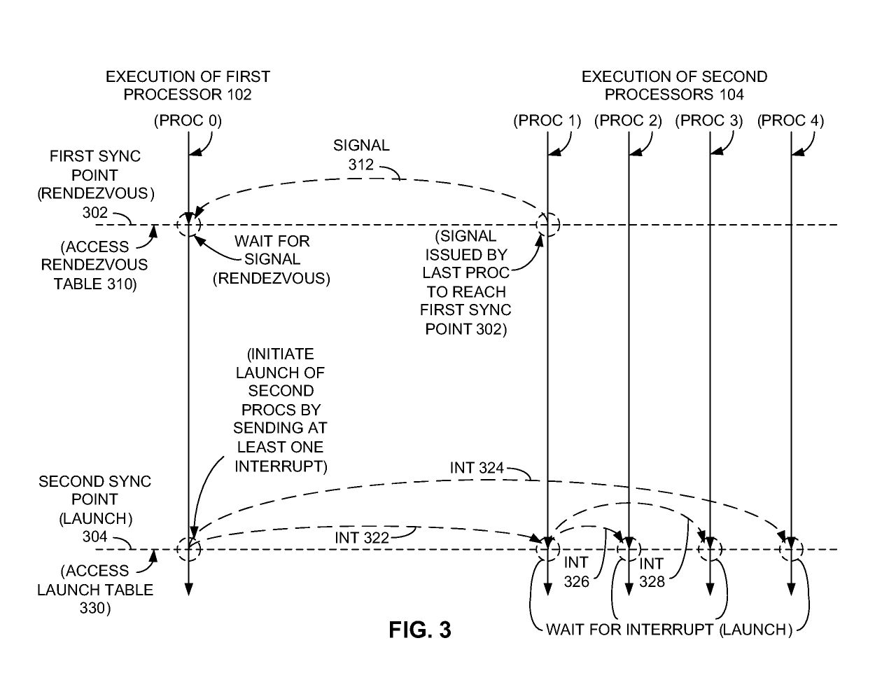

FIG. 3 graphically characterizes the execution of the first processor 102 and four separate second processors 104 according to a more detailed embodiment of the invention. While four separate second processors 104 are employed in this particular example, any number of second processors 104 greater than one may be utilized in other embodiments. For identification purposes, the first processor 102 is identified as Processor 0, while the second processors 104 are labeled Processors 1-4. Execution of each of the processors 102, 104 is depicted as progressing from top to bottom in relation to a first synchronization point 302 and a second synchronization point 304. In one embodiment, the first synchronization point 302 is a rendezvous or gathering point for the processors 102, 104, while the second synchronization point 304 is a launching point from which the processors 102, 104 continue execution. Although the synchronization points 302, 304 are represented in FIG. 3 as being located in completely separate areas of the execution stream of each of the processors 102, 104, the first synchronization point 302 and the second synchronization point 304 may represent approximately the same point in the execution thread of any or all of the processors 102, 104 in another example.

In FIG. 3, the first processor 102 executes until reaching the first synchronization point 302, whereupon the first processor 102 waits for a signal 312 from one of the second processors 104. Meanwhile, each of the second processors 104 executes through the first synchronization point 302 to the second synchronization point 304. Each of the second processors 104 accesses a rendezvous table 310 at the first synchronization point 302 to indicate that the accessing second processor 104 has reached the first synchronization point 302. The second processor 104 that is last to reach the first synchronization point 302 issues the signal 312 to the first processor 102 so that it may continue execution.

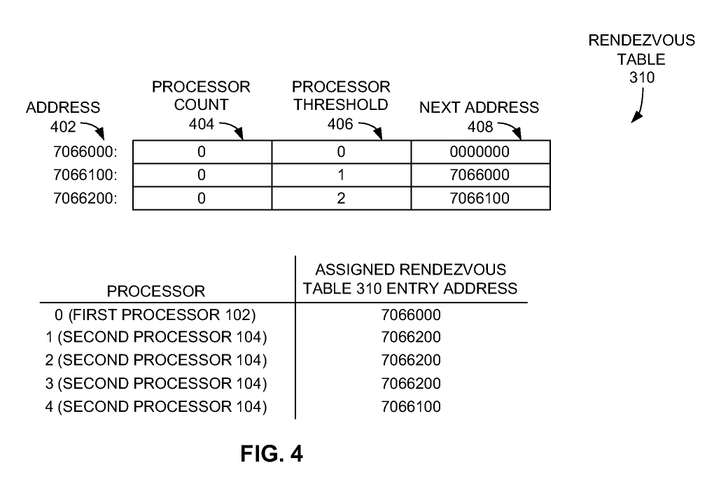

FIG. 4 illustrates one specific example of the rendezvous table 310 that each of the second processors 104 accesses to indicate its arrival at the first synchronization point 302. The rendezvous table 310 includes several entries, wherein each entry is depicted in FIG. 3 as a row. Further, each entry is associated with an address 402, and includes three fields: a processor count field 404, a processor threshold field 406, and a next address field 408. Also shown in FIG. 4 is the entry of the rendezvous table 310 that is associated with each of the processors 102, 104, identified by the address 402 of the entry.

As each second processor 104 reaches the first synchronization point 302, that second processor 104 accesses the entry of the rendezvous table 310 to which it is assigned. The second processor 104 then performs an atomic read-modify-write operation of the processor count field 404 of that entry and compares the value read from the processor count field 404 to the processor threshold field 406. If the values are equal, the second processor 104 then accesses the rendezvous table 310 entry indicated in the next address field 408 in the same fashion as the previous entry. This process continues for each of the second processors 104 until an accessed processor count field 404 is found to be less than its associated processor threshold field 406.

Using the scenario depicted in FIGS. 3 and 4 as an example, Processors 1-3 are each assigned the rendezvous table 310 entry located at address 7066200. Each of these second processors 104 reads the processor count field 404 of that entry and compares it to the processor threshold field 406. Thus, the first of Processors 1-3 that reaches the first synchronization point 302 and accesses the rendezvous table 310 entry at 7066200 reads a value of zero from the processor count field 404 and writes the incremented value of one back to the processor count field 404. That processor also compares the value of zero read from the processor count field 404 to the processor threshold 406 of two, and ceases this particular access of the rendezvous table 310 as a result. Similarly, the second of the Processors 1-3 to reach the first synchronization point 302 accesses the same entry of the rendezvous table 310, resulting in a value of two being stored for the processor count field 404 at address 7066200.

Continuing in this manner, the third of the Processors 1-3 to pass through the first synchronization point 302 accesses the same entry. However, after reading a value of two from the processor count field 404 and writing back a three thereto, that particular second processor 104 compares the two to the processor threshold 406 of two, and after finding that they are equal, accesses the next address field 408, which stores an address of 7066100. The last of the Processors 1-3 reaching the first synchronization point 302 then accesses the entry of the rendezvous table 310 at the address of 7066100 and repeats the process. Assuming this processor 104 reaches the first synchronization point 302 before Processor 4 (the operation of which is addressed below), the processor count field 404 of zero is read, a one is written back thereto, and the zero is compared to the processor threshold field 406 of one. As a result, the last of these second processors 104 (i.e., Processors 1-3) ceases its access of the rendezvous table 310.

Proceeding with the example of FIGS. 3 and 4, the second processor 104 referred to as Processor 4 also accesses the entry of the rendezvous table 310 at address 7066100 when it reaches the first synchronization point 302. In this case, Processor 4 is the last second processor 104 to reach the first synchronization point 302. After reading the value of one from the processor count field 404 (written therein by the last of Processors 1-3, as described above), Processor 4 compares the one to the value of one written in the processor threshold field 406. With these two values being equal, Processor 4 reads the next address field 408 that holds the value of 7066000. Processor 4 then reads the rendezvous table 310 entry at that address, reads the processor count field 404 of zero, stores the incremented value of one thereto, and compares the zero to the zero stored in the processor threshold field 406 of that entry. With the compared values being equal, Processor 4 then reads the next address field 408 of that entry, which holds the value 0000000. In this embodiment, reading all zeros indicates to Processor 4 that it is the last of the second processors 104 to reach the first synchronization point 302.

In response to being the last of the second processors 104, Processor 4 sends a signal 312 to Processor 0 (i.e., the first processor 102 of FIG. 3). The signal 312 may be issued in a number of ways. In one embodiment, the act of Processor 4 writing a one to the processor count field 404 of the rendezvous table 310 entry at address 7066000 may serve as the signal 312. In that case, Processor 0 may poll the processor count field 404 for a one to be written thereto, interpreting the one as the signal 312. In another implementation, Processor 4 writes a separate memory location, sends a message to Processor 0, or performs some other operation to implement the signal 312 to Processor 0. In addition, Processor 0 or Processor 4 may clear the processor count field 404 of each entry of the rendezvous table 310 to initialize the table 310 for the next time the first synchronization point 302 or other similar rendezvous point is employed.

Write operations to the processor count fields 404 as described above specifically employ an atomic read-modify-write operation often used in multiprocessor systems for processor intercommunication so that conflicts in accessing the field 404 will not arise between two or more of the second processors 104. For example, use of an atomic operation eliminates the possibility that two of the second processors will read the same value from the same processor count field 404. Other memory accesses that prevent such conflicts, such as standard “semaphore” or “mailbox” operations, could be utilized in other embodiments.

By employing multiple rendezvous table 310 entries, a hierarchical structure of memory locations is formed by which the second processors 104 indicate reaching the first synchronization point 302. Thus, by spreading the access to the rendezvous table 310 by each of the second processors 104 across multiple memory locations, access contention for those locations, which potentially is exacerbated by the atomic memory operations, is greatly decreased, resulting in faster signaling of the first processor 102. In addition, the particular embodiment of FIG. 4 allows generation of the signal 312 by way of a single access of the processor count field 404 of address 7066000, which the first processor 102 may be polling, as described above. In contrast to a single counter being updated by each of the second processors 104 while the first processor 102 polls the same memory location, the hierarchical model of FIG. 4 provides a more efficient method for processor synchronization.

A similar hierarchical model employing interrupts is utilized in FIG. 3 in launching the second processors 104 from the second synchronization point 304. More specifically, after the first processor 102 (i.e., Processor 0) receives the signal 312, the first processor 102 resumes execution to the second synchronization point 304, at which time it initiates a launch of each of the second processors 104 (i.e., Processors 1-4) by sending a first interrupt 322 to one of the second processors 104, which is Processor 1 in the embodiment of FIG. 3. In this specific example, Processor 0 also issues a second interrupt 324 to Processor 4. In turn, after receiving the first interrupt 322, Processor 1 issues a third interrupt 326 to Processor 2, and a fourth interrupt 328 to Processor 3. In response to receiving one of the interrupts 322-328, each of the second processors 104 then continues execution from the second synchronization point 304, along with the first processor 102. Thus, the first synchronization point 302 and the second synchronization point 304 are employed together to rendezvous and subsequently launch the processors 102, 104.

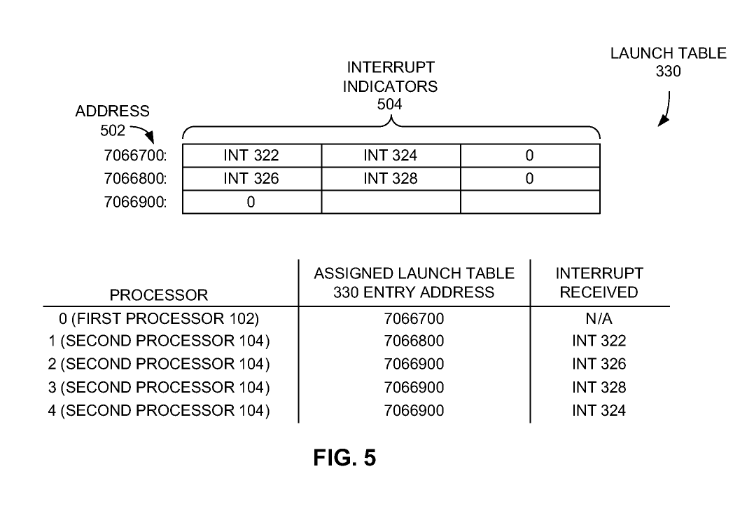

FIG. 5 graphically shows an embodiment of a launch table 330 accessed by each of the Processors 0-4 to perform the hierarchically-structured launch. As with the rendezvous table 310, the launch table 330 includes a number of entries, each of which is accessible via an address 502. Within each entry reside one or more interrupt indicators 504, wherein each indicator 504 is associated with a particular launch interrupt. In one embodiment, each interrupt indicator 504 is an interrupt mask and enable value that specifies an interrupt associated with a particular second processor 104. Thus, the processor 102, 104 issuing the interrupt may merely write the data stored at the interrupt indicator 504 to a location that causes the processor 102, 104 to generate the interrupt. Other indicators, such as a simple binary value indicating the specific second processor 104 to be launched, may be used in other examples. FIG. 5 also indicates the launch table 330 entry address and interrupt associated with each of the processors 102, 104.

In the particular example of FIG. 5, Processor 0 (i.e., the first processor 102) accesses its assigned launch table 330 address 7066700 after reaching the second synchronization point 304. The entry at address 7066700 indicates that interrupts are to be issued to Processor 1 (by way of interrupt 322) and Processor 4 (via interrupt 324), as shown in the interrupt indicators 504 of that entry. Further according to the embodiment of FIG. 5, an interrupt indicator 504 of zero denotes the end of the list of interrupts to be issued by the processor accessing the associated entry of the launch table 330.

After receiving its launch interrupt 322, Processor 1 accesses its assigned launch table entry 330 at address 7066800, which indicates that Processor 1 is to issue launch interrupts 326 and 328 for Processors 2 and 3, respectively. Similarly, Processor 4 accesses its assigned entry at address 7066900 in response to receiving interrupt 324 from Processor 0. However, the entry at address 706900 lists no further launch interrupts to be issued. Similarly, Processors 2 and 3 access the same entry in response to receiving interrupts 326, 328, and find that they are not responsible for issuing any launch interrupts, either. As a result, each of the second processors 104 has received a launch interrupt, even though the first processor 102 has only issued two launch interrupts directly. As a result, the work required to issue the interrupts has been distributed among the processors 102, 104 in a hierarchical fashion, thus hastening the launch process.

In one embodiment, the rendezvous table 310, the launch table 330, and the assigned table addresses for each of the processors 102, 104 are initialized by one or more of the processors 102, 104. According to another implementation, a separate processor not discussed above may perform this function. Once the tables 310, 330 are initialized, further setup of the tables 310, 330 may not be required during the use of multiple synchronizations of the processors 102, 104.

The use of the two synchronization points 302, 304 may be advantageous in a number of processing contexts. In one example, each of the processors 102, 104 may act as a producer of service requests before the first synchronization point 302 and after the second synchronization point 304. In response, the first processor 102 may then process or consume the service requests after the first synchronization point 302 and before the second synchronization point 304 while the second processors 104 remain idle at the second synchronization point 304. The service requests may constitute requests for any service that may be provided by the first processor 102, including but not limited to generating billing records, or searching and retrieving items in a database.

In another example, the first synchronization point 302 may be used to implement a “join” operation employed in a MIMD multiprocessing system, while the second synchronization point 304 may be utilized as part of a “fork” operation. In such an environment, the first processor 102 may execute a single thread after the first synchronization point 302 while the second processors 104 wait to be called on at their second synchronization point 304. The first processor 104 may then execute a fork operation to spawn the second processors 104 by way of the launch process from the second synchronization point 304, as described above. As each of the second processors 104 then finishes the work to which it was assigned, execution in that second processor 104 reaches the next first synchronization point 302. The last of the second processors 104 to reach the first synchronization point 302 then issues the signal 312 to the first processor 102, thus joining the execution of the processors back together. The first processor 102 may then operate as a lone thread until another fork operation is undertaken at another second synchronization point 304.

Various embodiments of a multiprocessor system and method as discussed above may provide significant benefits. Since a combination of simple shared memory communication and individual interrupts is employed to effectuate the rendezvous and launch processes, the embodiments may be implemented on most multiprocessing systems. In addition, the use of a logical processor hierarchy among the second processors 104, with the first processor 102 residing at the top of the hierarchy, facilitates quick execution of both the rendezvous and launch phases of the synchronization.

While several embodiments of the invention have been discussed herein, other embodiments encompassed by the scope of the invention are possible. For example, while many embodiments as described above specifically involve the use of a handful of processors within a multiprocessor system, other embodiments employing many more processors coupled together within a single system may exhibit even greater advantages over more serially oriented solutions due to the hierarchical nature of the synchronization mechanisms distributing the required work among many more processors. Further, aspects of one embodiment may be combined with those of alternative embodiments to create further implementations of the present invention. Thus, while the present invention has been described in the context of specific embodiments, such descriptions are provided for illustration and not limitation. Accordingly, the proper scope of the present invention is delimited only by the following claims and their equivalents.

What is claimed is:

1. A method for synchronizing a first processor and second processors, the method comprising:
in each of the second processors, waiting at a second synchronization point after reaching a first synchronization point;
in the last of the second processors to reach the first synchronization point, sending the first processor a signal;
in the first processor, waiting at the first synchronization point until receiving the signal, and initiating a launch of the second processors after receiving the signal by launching one of the second processors, wherein the one of the second processors launches another one of the second processors in response to being launched; and
in each of the second processors, continuing execution from the second synchronization point in response to being launched.

2. The method of claim 1, wherein:
initiating the launch of the second processors comprises initiating a plurality of interrupts;
launching the one of the second processors comprises sending a first of the interrupts to the one of the second processors; and
launching the other one of the second processors comprises sending one of the remaining interrupts to the other one of the second processors in response to receiving the first interrupt.

3. The method of claim 2, further comprising:
in each of the second processors, after receiving one of the interrupts, sending another one of the interrupts to another one of the second processors if indicated in a memory location assigned to the second processor sending the other one of the interrupts.

4. The method of claim 3, wherein sending another one of the interrupts comprises writing to a memory-mapped address indicated in the memory location assigned to the second processor sending the other one of the interrupts.

5. The method of claim 1, further comprising:
in each of the second processors, after reaching the first synchronization point, updating at least one of a plurality of memory locations, wherein the memory locations indicate whether all of the second processors have reached the first synchronization point.

6. The method of claim 5, wherein updating at least one of the plurality of memory locations comprises performing at least one atomic memory update operation on the at least one of the memory locations.

7. The method of claim 6, wherein sending the first processor the signal comprises writing to one of the plurality of memory locations.

8. The method of claim 1, further comprising:
in the first processor, continuing execution from the first synchronization point to the second synchronization point in response to receiving the signal, and initiating the plurality of interrupts after reaching the second synchronization point.

9. The method of claim 8, further comprising:
in the processors, generating service requests for the first processor during execution before the first synchronization point and after the second synchronization point;
wherein continuing execution in the first processor from the first synchronization point to the second synchronization point in response to receiving the signal comprises processing the service requests.

10. The method of claim 8, wherein:
the first synchronization point is associated with a join operation of a multi-threaded program; and
the second synchronization point is associated with a fork operation of the multi-threaded program.

11. The method of claim 1, wherein the first synchronization point comprises the second synchronization point.

12. A computer-readable storage medium comprising instructions executable on a first processor and second processors for employing a method for synchronizing the processors, the method comprising:
in each of the second processors, waiting at a second synchronization point after reaching a first synchronization point;
in the last of the second processors to reach the first synchronization point, sending the first processor a signal;
in the first processor, waiting at the first synchronization point until receiving the signal, and initiating a launch of the second processors after receiving the signal by launching one of the second processors, wherein the one of the second processors launches another one of the second processors in response to being launched; and
in each of the second processors, continuing execution from the second synchronization point in response to being launched.

13. A multiprocessor system, comprising:
a first processor configured to wait at a first synchronization point until receiving a signal; and
second processors, wherein each of the second processors is configured to wait at a second synchronization point after reaching the first synchronization point, and to send the signal to the first processor if last of the second processors to reach the first synchronization point;
wherein the first processor is configured to initiate a launch of the second processors after receiving the signal by launching one of the second processors;
wherein the one of the second processors is configured to launch another one of the second processors in response to being launched; and
wherein each of the second processors is configured to continue execution from the second synchronization point in response to being launched.

14. The multiprocessor system of claim 13, wherein:
the first processor is configured to initiate the launch of the second processors by initiating a plurality of interrupts, and to launch one of the second processors by sending a first of the interrupts to one of the second processors; and
the one of the second processors is configured to launch another one of the second processors by sending at least one of the remaining interrupts in response to receiving the first interrupt.

15. The multiprocessor system of claim 14, wherein each of the second processors is configured to send another one of the interrupts to another one of the second processors after receiving one of the interrupts if indicated in a memory location assigned to the second processor sending the other one of the interrupts.

16. The multiprocessor system of claim 15, wherein each of the second processors is configured to send another one of the interrupts by writing to a memory-mapped address indicated in the memory location assigned to the second processor sending the other one of the interrupts.

17. The multiprocessor system of claim 13, wherein each of the second processors is configured to update at least one of a plurality of memory locations after reading the first synchronization point, wherein the memory locations indicate whether all of the second processors have reached the first synchronization point.

18. The multiprocessor system of claim 17, wherein each of the second processors is configured to update at least one of the plurality of memory locations by performing at least one atomic memory update operation on the at least one of the memory locations.

19. The multiprocessor system of claim 18, wherein each of the second processors is configured to send the first processor the signal by writing to one of the plurality of memory locations.

20. The multiprocessor system of claim 13, wherein the first processor is configured to continue execution from the first synchronization point to the second synchronization point in response to receiving the signal, and to initiate the plurality of interrupts after reaching the second synchronization point.

21. The multiprocessor system of claim 20, wherein:
each of the processors are configured to generate service requests for the first processor during execution before the first synchronization point and after the second synchronization point; and
the first processor is configured to continue execution from the first synchronization point to the second synchronization point in response to receiving the signal by processing the service requests.

22. The multiprocessor system of claim 20, wherein:
the first synchronization point is associated with a join operation of a multi-threaded program; and
the second synchronization point is associated with a fork operation of the multi-threaded program.

23. The multiprocessor system of claim 13, wherein the first synchronization point comprises the second synchronization point.
